(19) United States
(12) Patent Application Publication
(10) Pub. No.: US 2014/0309827 A1
(43) Pub. Date: Oct. 16, 2014

(54) MOTOR VEHICLE HAVING TRACTION MOTOR

(71) Applicants: TOYOTA JIDOSHA KABUSHIKI KAISHA, Toyota-shi, Aichi-ken (JP); DENSO CORPORATION, Kariya-shi, Aichi-ken (JP)

(72) Inventors: Takao Kanzaki, Miyoshi-shi (JP); Koichi Sakata, Okazaki-shi (JP); Yusuke Shindo, Nagoya-shi (JP); Yasuaki Igarashi, Kasugai-shi (JP)

(73) Assignees: DENSO CORPORATION, Kariya-shi, Aichi-ken (JP); TOYOTA JIDOSHA KABUSHIKI KAISHA, Toyota-shi, Aichi-ken (JP)

(21) Appl. No.: 14/352,543

(22) PCT Filed: Oct. 17, 2012
(86) PCT No.: PCT/IB2012/002096

§ 371 Date: Apr. 17, 2014

(30) Foreign Application Priority Data
Oct. 18, 2011 (JP) 2011-228423

(51) Int. Cl. B60L 3/00

(52) U.S. Cl. CPC B60L 3/00; Y10S 903/903
USPC 701/22; 180/65.275; 903/903

(57) ABSTRACT

A motor vehicle includes an electric motor, a smoothing capacitor, a discharge device and a controller. The smoothing capacitor smoothes the electric current that is used to drive the electric motor. The discharge device is capable of releasing the electric charge stored in the capacitor. The controller is configured to receive sensor data that indicates a state of the motor vehicle and determine whether to activate a discharge device, based on the sensor data received.

### BACKGROUND OF THE INVENTION

1. Field of the Invention

The invention relates to a motor vehicle equipped with a traction motor (a vehicle-driving electric motor). Particularly, the invention relates to a hybrid vehicle or an electric motor vehicle. The “motor vehicle” in this specification includes a fuel cell vehicle as well.

2. Description of Related Art

Hybrid vehicles and electric motor vehicles are equipped with an inverter that converts direct current supplied from a battery into alternating current. The inverter that converts electric current is equipped with a capacitor that smoothes electric current (smoothing capacitors) in order to stably output alternating current. Generally, the smoothing capacitor is connected between input terminals of the inverter. Furthermore, some of the hybrid vehicles and electric motor vehicles are equipped with a DC/DC converter that converts the output voltage of the battery into a voltage suitable to be input to the inverter. In such cases, a smoothing capacitor is sometimes connected also to the input side of the DC/DC converter. Since large electric power is needed in order to drive a traction motor, those smoothing capacitors used in hybrid vehicles or fuel cell vehicles are ones that have a large capacitance.

In order to secure safety at the time of crash of a vehicle, it is preferable that the electric motor-driven motor vehicles have a mechanism that promptly discharges or releases electric charge accumulated in the smoothing capacitors. Technologies related to such a mechanism are disclosed in, for example, Japanese Patent Application Publication No. 2007-181308 (JP 2007-181308 A), Japanese Patent Application Publication No. 2006-141158 (JP 2006-141158 A), Japanese Patent Application Publication No. 2006-224772 (JP 2006-224772 A), and Japanese Patent Application Publication No. 2010-178595 (JP 2010-178595 A)). JP 2007-181308 A discloses a technology that consumes (releases) the electric charge stored in a smoothing capacitor, by using the stored electric charge to operate the horn or the headlights. JP 2006-141158 A discloses a technology that consumes the electric charge stored in a smoothing capacitor, by using the stored electric charge to drive an electric motor. JP 2006-224772 A discloses a technology that includes a discharge circuit that employs a discharge resistor. JP 2010-178595 A discloses a technology that includes two kinds of discharge mechanisms and that activates a second discharge mechanism when the discharging by the first discharge mechanism is insufficient. Hereinafter in this specification, the devices that are capable of discharging (consuming) the electric charge stored in a smoothing capacitor will be collectively referred to as “discharge device”. Examples of the discharge device are the horn and the headlights in JP 2007-181308 A, the electric motor in JP 2006-141158 A, the discharge resistor in JP 2006-224772 A, the two kinds of discharge mechanisms in JP 2010-178595 A. Other examples of the discharge device include power transistors provided in inverters or DC/DC converters. A representative example of the power transistors is an IGBT. Furthermore, instead of the expression “power transistor”, the expression “power switching device” is sometimes used. The switching loss of a power transistor can be used for discharge.

Any one of the foregoing documents proposes a technology that efficiently carries out the discharging when the vehicle collides. It is to be noted herein that a controller of a motor vehicle determines whether the vehicle has collided, on the basis of the magnitude of an impact (acceleration) exerted on the vehicle. The impact (acceleration) exerted on the vehicle, typically, is measured by an acceleration sensor that is incorporated in an airbag system. Alternatively, a sensor that employs a conductive wire that breaks upon receiving an impact of a certain magnitude or greater is also a type of acceleration sensor.

A controller that manages the acceleration sensor (e.g., an airbag controller) outputs a signal that shows that the vehicle has collided, when the impact (acceleration) exerted on the vehicle is greater than a predetermined threshold value. Hereinafter, the signal that shows that the vehicle has collided will be simply referred to as “collision signal”. A controller that controls a discharge device activates the discharge device upon receiving the collision signal. However, it is not always preferable to activate the discharge device in the same manner upon receiving the collision signal.

### SUMMARY OF THE INVENTION

The invention provides a traction motor-equipped motor vehicle capable of causing a discharge device to appropriately operate according to situation.

A motor vehicle having a traction motor according to one aspect of the invention includes: a capacitor that smoothes electric current that is used to drive the traction motor; a discharge device capable of releasing electric charge stored in the capacitor; and a control section configured to receive sensor data that indicates a state of the motor vehicle and to determine, based on the sensor data received whether activation of the discharge device should be prohibited.

A signal that shows a collision of the vehicle can sometimes be sent when no collision has occurred in reality, for some cause. In the case where the control section that controls the discharge device is configured to determine that a collision of the vehicle has occurred when there is a decline in the power supply voltage and is configured to activate the discharge device on the basis of such a determination, it is not preferable to activate the discharge device when the power supply voltage declines due to a cause other than a collision of the vehicle (e.g., when the power supply voltage declines due to degradation of the battery).

The control section that controls the discharge device may, for example, constantly and repeatedly receive and retain the sensor data that indicates a state of the vehicle. The control section determines whether activation of the discharge device should be prohibited, based on the sensor data received. In other words, the control section determines whether to allow or prohibit activation of the discharge device, based on the sensor data that indicates a state of the vehicle. In the case where the control section determines that activation of the discharge device should be prohibited, the control section does not activate the discharge device even if the control section receives the collision signal. The control section may be separate from the discharge device. In this case, the control section may be configured to constantly send to the discharge device a result of determination as to whether activation of the discharge device should be prohibited. Alternatively, the control section may be integrated with the discharge device.

Typical examples of the sensor data that indicates a state of the vehicle includes the vehicle speed, the input voltage of an inverter, the battery voltage, the temperature of a cooling medium that cools the inverter or an electric motor, the temperature of a switching element provided in the inverter, etc. The control section may determine whether activation of the discharge device should be prohibited, by using at least one of the above-listed pieces of sensor data. For example, in the case where the vehicle speed is higher than a predetermined threshold speed value, the possibility of a collision having occurred is low, and therefore it is preferable not to activate the discharge device even if the collision signal is received. Therefore, in the case where the vehicle speed is higher than the predetermined threshold speed value, the control section may prohibit activation of the discharge device. In the foregoing motor vehicle, since the control section that controls the discharge device determines whether activation of the discharge device should be prohibited, based on the sensor data that indicates a state of the vehicle, it is possible to cause the discharge device to appropriately operate according to the situation.

The control section may be configured to periodically receive sensor data that indicates a state of the vehicle and determine whether activation of the discharge device should be prohibited, based on the sensor data. According to this configuration, the control section is able to always monitor the state of the vehicle.

The control section may be configured so that, when the motor vehicle receives an impact (when a collision signal is input to the control section), the control section determines whether activation of the discharge device should be prohibited, based on the sensor data that the control section receives before the motor vehicle receives the impact. Since the sensor data obtained before a collision is high in reliability, the control section, is able to make an appropriate determination.

In a preferred manner of receiving and retaining the sensor data, the control section receives the sensor data every predetermined time, and updates the retained previous sensor data with the latest sensor data. Furthermore, the control section may be configured to determine whether activation of the discharge device should be prohibited, based on the sensor data that the control section receives at least a predetermined time before the motor vehicle receives the impact. In the former case, it is possible to always use the latest sensor data (the sensor data that immediately precedes a collision). In the latter case, sensor data acquired simultaneously with a collision, which is expected to be low in reliability, can be prevented from being used as a basis for the determination. Incidentally, the “predetermined time before” is not required to be strictly a predetermined time before. It is to be noted that the time expressed by the phrase “predetermined time before” includes, for example, a period between one second before and five seconds before”.

The “when the motor vehicle receives an impact” may be when acceleration measured by an acceleration sensor provided in the motor vehicle exceeds a predetermined threshold acceleration value. The motor vehicle may further include an acceleration sensor, wherein the control section is configured to determine that the motor vehicle has received the impact, when acceleration measured by the acceleration sensor exceeds a predetermined threshold acceleration value. In the foregoing motor vehicle, the control section may be disposed in a front compartment of the motor vehicle, and the acceleration sensor may be disposed in a cabin compartment.

In a typical example, the discharge device may include at least one of a discharge resistor, the traction motor, a power transistor provided in an electric motor controller, as mentioned above. In the case where a discharge resistor is used as a discharge device, an example of the sensor data is the input voltage of an inverter provided in the electric motor controller. When the input voltage is excessively large, it is sometimes not appropriate to activate the discharge resistor. For example, when the input voltage is large, large electric charge is stored in the smoothing capacitor. In the case where an electric power that exceeds the capacity of the discharge resistor flows into the discharge resistor, it sometimes happens that the discharge resistor is broken and expected discharge cannot be achieved. Therefore, the discharge device may include a discharge resistor, the sensor data may include input voltage of an inverter provided in the electric motor controller, and the control section may be configured to activate the discharge device if the input voltage is lower than a predetermined upper limit voltage and not to activate the discharge device if the input voltage is higher than the upper limit voltage. By adopting such a configuration, it becomes possible to discharge the smoothing capacitor in such a range that the discharge resistor is not broken.

On the other hand, in the case where the electric charge stored in the smoothing capacitor is excessively small, there is no need to activate the discharge resistor. Therefore, the control section may be configured to activate the discharge device if the input voltage is higher than a predetermined lower limit voltage that is lower than the upper limit voltage and not to activate the discharge device if the input voltage is lower than the lower limit voltage.

Furthermore, the discharge device may include a power transistor provided in an electric motor controller, and the sensor data may include temperature of the power transistor or temperature of a cooling medium that cools the power transistor, and the control section may be configured to activate the discharge device if the temperature of the power transistor or the temperature of the cooling medium is lower than a predetermined upper limit temperature and not to activate the discharge device if the temperature of the power transistor or the temperature of the cooling medium is higher than the upper limit temperature. In the case where a power transistor in the electric motor controller is used as a discharge device (including the case where one electric motor is used for both purposes), an example of the sensor data that the control section receives and retains is the temperature of the power transistor or the temperature of the cooling medium that cools the power transistor. If the electric motor is heavily used prior to a collision, the temperature of the power transistor rises. If the temperature of the power transistor is excessively high, the release of the electric charge stored in the smoothing capacitor may break the power transistor in a short time. That is, there is a possibility that the expected discharge is not achieved. In such a case, it is preferable to avoid using the power transistor (and the electric motor) as a discharge device. Therefore, it is desirable that the control section activate the discharge device if the temperature of the power transistor is lower than the predetermined upper limit temperature, and do not activate the discharge device if the temperature of the power transistor is higher than the upper limit temperature. It is to be noted herein that an example of the upper limit value of the temperature range is the upper limit value of the temperature range of the power transistor that is normally operating. Furthermore, instead of the temperature of the power transistor, the temperature of the cooling medium may be used. The upper limit temperature of the cooling medium temperature may be different from the upper limit temperature of the temperature of the power transistor.

The control section may include a storage section configured to retain a result of determining whether activation of the discharge device should be prohibited, and the control section may be configured not to activate the discharge device or to stop operation of the discharge device when the result of the determining that activation of the discharge device should be prohibited is retained in the storage section.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic system block diagram of a motor vehicle in accordance with a first embodiment of the invention;

FIG. 2 is a control block diagram showing an internal construction of a power controller;

FIG. 3 is a flowchart of an example of a sensor data update process;

FIG. 4 is a flowchart of an example of a process performed when a collision signal is received;

FIG. 5 is a flowchart of a process performed at the time of reception of a collision signal in a second embodiment of the invention;

FIG. 6 is a flowchart of a discharge process in a third embodiment of the invention; and

FIG. 7 is a flowchart of a discharge process in a fourth embodiment of the invention.

### DETAILED DESCRIPTION OF EMBODIMENTS

### First Embodiment

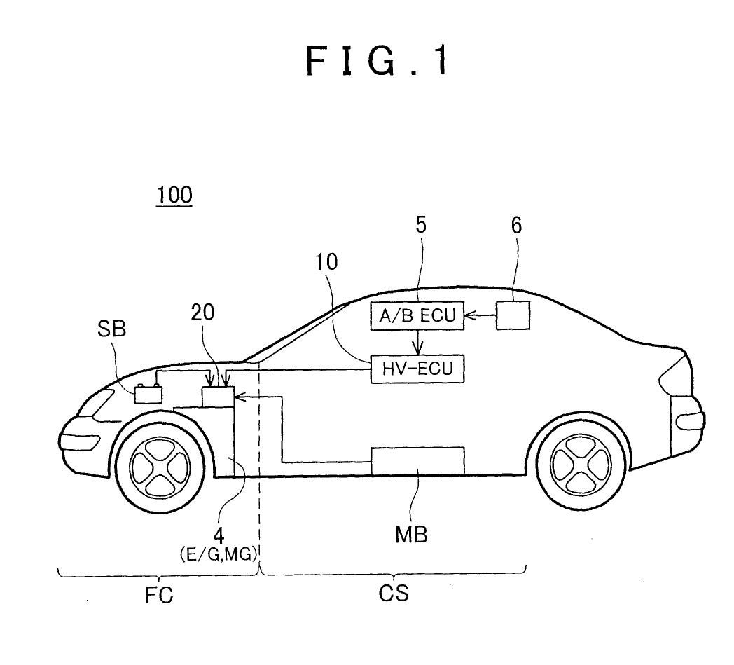

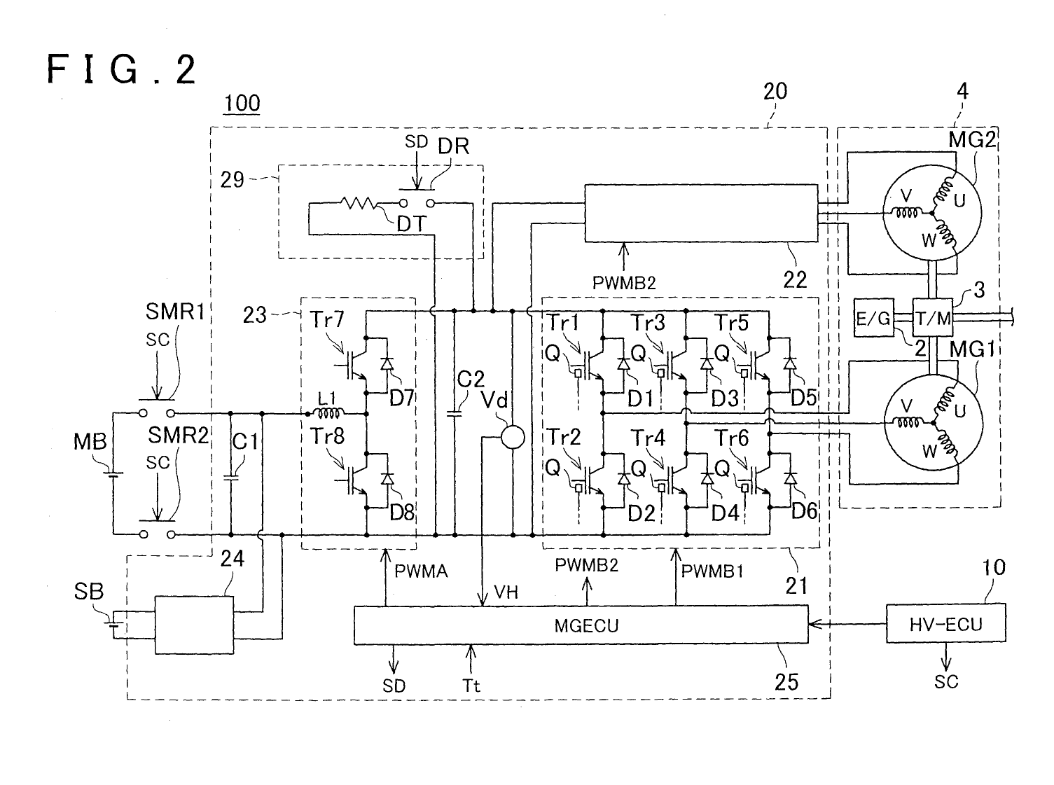

A motor vehicle in accordance with a first embodiment of the invention will be described with reference to the accompanying drawings. A motor vehicle 100 of the first embodiment is a hybrid vehicle including an engine 2 and two electric motors (MG1 and MG2). FIG. 1 shows a schematic system block diagram of the motor vehicle 100. FIG. 2 shows a control block diagram showing an internal construction of a power controller 20 that controls the two electric motors MG1 and MG2. It is to be noted that the system block diagram of FIG. 1 shows only units related to the invention while various units that the motor vehicle 100 has are omitted from the illustration. Besides, the “power controller” is sometimes termed the power control unit (PCU) as well.

The power controller 20 converts output voltage of a main battery MB into a voltage suitable for electric motor control, and converts the converted direct-current (DC) power into alternating-current (AC) power, and supplies the converted AC power to the electric motors MG1 and MG2. The power controller 20 will be described in detail later.

The engine 2 and the two electric motors (MG1 and MG2), together with a transmission 3, constitute a drive train 4. It is well known that the hybrid vehicle uses the engine 2 and the electric motors MG1 and MG2 by switching between them according to the situation of the vehicle. When large torque is needed, the hybrid vehicle uses both the engine 2 and the electric motors MG1 and MG2 simultaneously. The transmission 3 in the drive train 4 switches between the output of the engine 2 and the outputs of the electric motors MG1 and MG2 or combine the outputs thereof, and transfers the output drive force to a differential unit. The electric motors MG1 and MG2 correspond to traction electric motors. The drive train 4 is sometimes termed the power train or the transaxle (T/A). Details of the structure of the drive train 4 are omitted from the description. The electric motors MG1 and MG2 also have a function of a generator that converts deceleration energy at the time of braking into electric energy (regenerative energy).

As shown in FIG. 1, the drive train 4, the power controller 20 and a sub-battery SB are disposed in a front compartment FC. The main battery MB that supplies electric power for driving the electric motors, an acceleration sensor 6 that detects the acceleration of the vehicle, an airbag controller 5 (A/B-ECU) that controls an airbag system, an HV controller 10 (HV-ECU) that manages and controls a hybrid system are disposed within a cabin space CS. The sub-battery SB supplies electric power for headlights and a car navigation system or electric power for driving electronic component parts (transistors and the like) provided within various controllers. In FIG. 1, a line connecting the sub-battery SB and the power controller 20 indicates an electric power supply line from the sub-battery SB to electronic component parts provided within the power controller 20. In many cases, the voltage that the sub-battery SB supplies is 12 V or 24 V while the voltage that the main battery MB supplies is 100 V or higher. The sub-battery SB corresponds to a battery that an engine-driven motor vehicle generally has.

Devices disposed in the cabin space CS will be described. The airbag controller 5, on the basis of the output of the acceleration sensor 6, deploys the airbags (not shown) when the impact (acceleration) exerted on the motor vehicle 100 exceeds a predetermined threshold acceleration value, and then sends to the HV controller 10 a signal that shows that the impact has exceeded the threshold acceleration value. It is to be noted herein that “the event in which the acceleration exerted on the motor vehicle 100 has exceeded the predetermined threshold acceleration value” means that the motor vehicle 100 had a collision. The HV controller 10 collects various sensor data regarding the hybrid system, and sends necessary commands to various controllers. The HV controller 10, upon receiving from the airbag controller 5 the signal that shows that the acceleration of the vehicle has exceeded the threshold acceleration value, sends a signal that has the same meaning (i.e., a signal that shows that the acceleration of the vehicle has exceeded the threshold acceleration value) to the power controller 20 that controls the electric motors. Hereinafter, the “signal that shows that the acceleration of the vehicle has exceeded the threshold acceleration value” will be referred to as “collision signal”.

With reference to FIG. 2, a structure of an electric system provided within the power controller 20 will be described. The power controller 20 generally has a first converter 23, a second converter 24, a first inverter 21, a second inverter 22, an electric motor controller 25 and a discharge module 29. The electric motor controller 25 receives commands from the HV controller 10, and outputs commands to various modules provided within the power controller 20.

The first inverter 21 is a module that generates AC power for driving the electric motor MG1, and includes six switching sets each of which is made up of a pair of a transistor Tr (power transistor) and a diode D. The transistors Tr are typically insulated gate bipolar transistors (IGBTs). The set of a first transistor Tr1 and a first diode D1 constitutes a U-phase upper arm of the electric motor MG1. The set of a second transistor Tr2 and a second diode D2 constitutes a U-phase lower arm. The set of a third transistor Tr3 and a third diode D3 constitutes a V-phase upper arm. The set of a fourth transistor Tr4 and a fourth diode D4 constitutes a V-phase lower arm. The set of a fifth transistor Tr5 and a fifth diode D5 constitutes a W-phase upper arm. The set of a sixth transistor Tr6 and a sixth diode D6 constitutes a W-phase lower arm. Adjacent to each transistor there is provided a temperature sensor Q that measures the temperature of the transistor. The second inverter 22 produces AC power that drives the electric motor MG2. The structure of the second inverter 22 is the same as the structure of the first inverter 21, and description thereof is omitted. A pulse width modulation (PWM) signal (PWMB1) that drives the first inverter 21 and a PWM signal (PWMB2) that drives the second inverter 22 are generated by the electric motor controller 25, and are sent from the controller 25 to the respective modules.

The first converter 23 is a DC/DC converter that raises the voltage of the main battery MB to a voltage suitable to drive the electric motors. In an example, the output voltage of the main battery MB is 300 V, and the voltage suitable to drive the electric motors MG1 and MG2 is 600 V. That is, the first converter 23 converts the input voltage of 300 V into 600 V. Besides, the first converter 23 is also able to lower the voltage of regenerative energy provided by the electric motors MG1 and MG2 to a voltage equal to the voltage of the main battery MB. The first converter 23 raises voltage when current flows from the left side to the right side in FIG. 2. Conversely, when current flows from the right side to the left side in FIG. 2, the first converter 23 lowers voltage. The first converter 23 is constructed of a reactor L1 and two switching sets each of which is made up of a transistor Tr and a diode D. The circuit constructions of the converters shown in FIG. 2 are well known, and detailed descriptions thereof are omitted. A PWM signal PWMMA that drives the first converter 23 is also generated by the electric motor controller 25.

A second converter 24 is a module that lowers the output voltage of the main battery MB to a voltage suitable for the sub-battery SB. The second converter 24 is used to charge the sub-battery SB.

On an electric power supply path from the main battery MB to the first converter 23, there are disposed system main relays SMR1 and SMR2 and a first smoothing capacitor C1. The system main relays SMR1 and SMR2 are relays, each of which can interrupt the electric power supply path from the main battery MB. A signal SC that controls the system main relays SMR1 and SMR2 is sent from the HV controller 10. The first smoothing capacitor C1 smoothes the current supplied from the main battery MB to the first converter.

On an electric power supply path from the first converter 23 to the inverter (the first inverter 21 and the second inverter 22), there are disposed a second smoothing capacitor C2 and a voltage sensor Vd. More precisely, the second smoothing capacitor C2 and the voltage sensor Vd are connected in parallel between two input terminals of the inverter. The second smoothing capacitor C2 smoothes the current that is input to the inverter. The voltage sensor Vd measures the inverter input voltage. The voltage VH that the voltage sensor Vd measures corresponds to the voltage across the second smoothing capacitor C2. Sensor data from voltage sensor Vd and sensor data from the temperature sensors Q that measure the temperature of the corresponding transistors are sent to the electric motor controller 25. In FIG. 2, the sensor data from the voltage sensor Vd, that is, the inverter input voltage, is represented by characters VH, and the sensor data from the temperature sensors Q, that is, the temperature of each transistor, is represented by characters Tt. These characters will be used also in the following description.

The discharge module 29 is constructed of a discharge resistor DT (discharge device) and a discharge relay DR. The discharge resistor DT is made of a high-resistance thick conductor. The energy of the current that flows in the discharge resistor DT mostly turns into heat and thus dissipates.. The discharge resistor DT is connected in parallel with the second smoothing capacitor C2, and the discharge relay DR is inserted as a switch between the discharge resistor DT and the second smoothing capacitor C2. In other words, when the discharge relay DR is closed, the discharge device (discharge resistor DT) activates. A signal SD that opens and closes the discharge relay DR is also sent from the electric motor controller 25. The discharge relay DR is normally open, and closes upon arrival of the signal SD from the electric motor controller 25. When the discharge relay DR closes, the electric charge stored in the second smoothing capacitor C2 flows out into the discharge resistor DT (discharge resistor DT activates), and is dissipated as heat. The discharge resistor DT is an example of the discharge device.

As stated above, the output voltage of the first converter 23, that is, the input voltage of the inverter, is a high voltage of 600 V. Therefore, while the vehicle is traveling, a large amount of electric charge is accumulated in the second smoothing capacitor C2. If the vehicle collides with an obstacle, it is preferable that the controller (electric motor controller 25) of the motor vehicle 100 release the electric charge stored in the first smoothing capacitor C1 and the second smoothing capacitor C2 for the sake of safety. Next, a process of discharging the second smoothing capacitor C2 when the vehicle has a collision will be described. It is to be noted that the construction and the process described below can also be applied to the first smoothing capacitor C1.

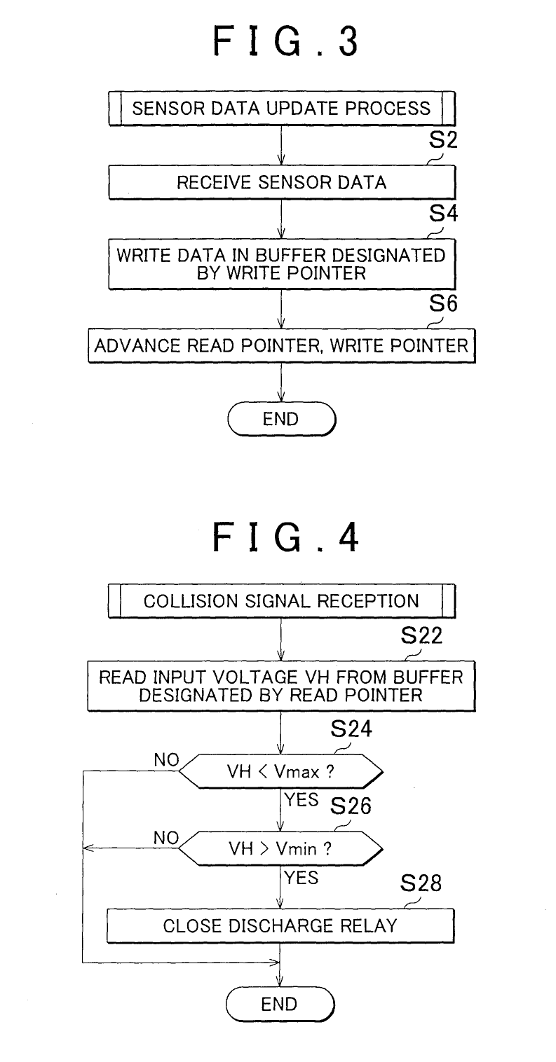

Prior to description of the process performed when the vehicle has a collision, a sensor data update process that the electric motor controller 25 performs will be described. The electric motor controller 25, after the ignition switch is turned on, executes a process of periodically acquiring and updating various kinds of sensor data. The electric motor controller 25 retains the acquired sensor data for a fixed period of time (e.g., 10 seconds). In this example, the electric motor controller 25 receives and retains the sensor data from the voltage sensor Vd (i.e., the inverter input voltage VH) and the sensor data from the temperature sensors Q (i.e., the temperature Tt of each power transistor Tr) at fixed intervals (e.g., every one second). These pieces of sensor data are examples of the sensor data indicating a state of the vehicle. An example of the process of retaining sensor data for a fixed period of time is shown in FIG. 3. In this example, the electric motor controller 25 adopts a ring buffer to retain the sensor data for a fixed period of time. The process shown in FIG. 3 is executed every one second. The ring buffer in this example is constructed of ten buffer regions. Physically, the ten buffer regions are memory portions provided in the electric motor controller 25. The ring buffer is provided with two pointers. A write pointer designates the address of a buffer (memory) to write the next piece of data in. A read point indicates the address of a buffer (memory) to read data from. The buffer that the write pointer designates and the buffer that the read pointer designates are five buffers apart from each other. The electric motor controller 25, upon receiving sensor data (data regarding the inverter input voltage VH and the transistor temperature Tt) (S2), writes the sensor data in the buffer that the write pointer designates (S4). Next, the electric motor controller 25 increments the values of the write pointer and the read pointer by one. Since sensor data is written in one buffer every one second and the buffer designated by the write pointer and the buffer designated by the read pointer are five buffers apart from each other, the buffer designated by the read pointer retains sensor data that was written five seconds before. That is, the sensor data stored in the buffer designated by the read pointer is data obtained five seconds before. Thus, the electric motor controller 25 retains sensor data for the past ten seconds, and is always able to read sensor data that is five seconds old. This five-second-old sensor data is used in a process performed at the time of collision (the process will be described below).

Next, a process performed when the electric motor controller 25 receives the collision signal from the HV controller 10 will be described. FIG. 4 is a flowchart of a process that the electric motor controller 25 executes upon receiving the collision signal. Incidentally, a signal line for sending the collision signal is connected to an interrupt terminal of a central processing unit (CPU) of the electric motor controller 25. In response to reception of the collision signal, the process shown in FIG. 4 is started as an interrupt process.

If the value of acceleration that the acceleration sensor 6 outputs exceeds a predetermined threshold value, the airbag controller 5 determines that the vehicle has collided, and sends a collision signal to the HV controller 10. Receiving the collision signal, the HV controller 10 opens the system main relays SMR1 and SMR2, and sends the collision signal to the electric motor controller 25. When the system main relays are opened, the supply of electric power from the main battery MB to the first converter 23 and to the inverters 21 and 22 is no longer performed. Incidentally, the collision signal that the HV controller 10 sends to the electric motor controller 25 is equivalent to a command for the electric motor controller 25 to discharge the second smoothing capacitor C2, and therefore will sometimes be referred to as “discharge command” below. After receiving the collision signal (discharge command), the electric motor controller 25 reads sensor data (inverter input voltage VH) from the buffer that the read pointer of the ring buffer designates (S22). The electric motor controller 25 compares the input voltage VH with a predetermined upper limit voltage Vmax and with a predetermined lower limit voltage Vmin (S24 and S26). If the input voltage VH is smaller than the upper limit voltage Vmax and is greater than the lower limit voltage Vmin (YES in S24 and YES in S26), the electric motor controller 25 closes the discharge relay DR (see FIG. 2) (S28). After the discharge relay DR is closed, the electric charge having been stored in the second smoothing capacitor C2 flows to the discharge resistor DT, and is dissipated as heat. In other words, in the case where the input voltage VH is higher than the upper limit voltage Vmax and in the case where the input voltage VH is lower than the lower limit voltage Vmin, the discharge relay DR is not closed. It is to be noted herein that the sensor data that is read from the ring buffer is data obtained five seconds before the time at which the collision signal is detected by the electric motor controller 25. In this embodiment, the electric motor controller 25 functions as the control section of the invention and the memory in the electric motor controller 25 functions as the storage section of the invention.

The upper limit voltage Vmax and the lower limit voltage Vmin are stored beforehand in the electric motor controller 25. The upper limit voltage Vmax corresponds to an upper limit of the amount of electric power that discharge resistor DT (discharge device) is able to deal with. The voltage across the second smoothing capacitor C2 (i.e., the electric charge stored in the second smoothing capacitor C2) changes depending on the magnitudes of the electric power supplied to the electric motors MG1 and MG2. Therefore, the process shown in FIG. 4 is intended to prevent activation of the discharge device if there is a possibility that if the electric charge stored in the second smoothing capacitor C2 is released, the discharge resistor DT may break and the expected effect of the discharging may not be obtained. The lower limit voltage Vmin corresponds to the case where the electric charge stored in the second smoothing capacitor C2 is so small that there is no need to activate the discharge device. The process of steps S24 and S26 corresponds to an example of a step of determining whether to activate the discharge device.

### Second Embodiment

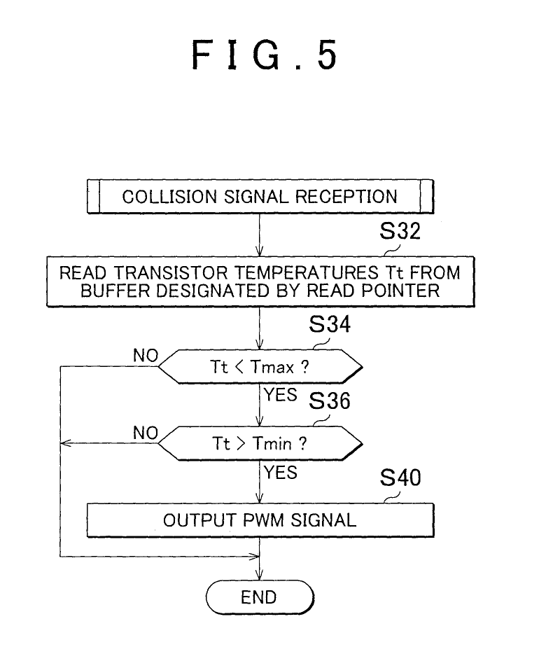

Next, a second embodiment of the invention will be described. The construction of a motor vehicle in accordance with the second embodiment is the same as that in the first embodiment, and description thereof will be omitted. The motor vehicle of the second embodiment uses the power transistors (Tr1 to Tr6) provided in the inverter and the electric motors MG1 and MG2 as discharge devices. Therefore, a process that the electric motor controller 25 executes upon detection of a collision is different from the process executed in the first embodiment. FIG. 5 shows a flowchart of a process that the electric motor controller 25 executes upon receiving the collision signal (discharge command) from the HV controller 10. Similarly to the first embodiment, the HV controller 10, upon receiving the collision signal from the airbag controller 5, sends a collision signal (discharge command) to the electric motor controller 25, and opens the system main relays SMR1 and SMR2.

When the process shown in FIG. 5 (interrupt process) starts, the electric motor controller 25 firstly reads sensor data (the temperature Tt of each transistor in this example) from the buffer that the read pointer of the above-described ring buffer designates (S32). The electric motor controller 25 compares the transistor temperature Tt with a predetermined upper limit temperature Tmax and a predetermined lower limit temperature Tmin (S34 and S36). If the transistor temperature Tt is lower than the upper limit temperature Tmax and higher than the lower limit temperature Tmin (YES in S34 and YES in S36), the electric motor controller 25 outputs a predetermined PWM signal to the first inverter 21 and to the second inverter 22 (S40). Due to the PWM signal given to the transistors Tr, the electric charge stored in the second smoothing capacitor C2 flows into the inverters 21 and 22. In the end, the electric charge left in the second smoothing capacitor C2 is consumed due to the switching loss of the power transistors (Tr1 to Tr6). Also in this embodiment, the electric motor controller 25 functions as the control section of the invention and the memory in the electric motor controller 25 functions as the storage section of the invention.

The upper limit temperature Tmax and the lower limit temperature Tmin are stored beforehand in the electric motor controller 25. The upper limit temperature Tmax and the lower limit temperature Tmin correspond to the upper limit temperature and the lower limit temperature of the temperature of the power transistors that are normally operating. That is, if the transistor temperature Tt is higher than the upper limit temperature Tmax, there is a high possibility that the transistors are operating in an overload state. If in such a case, the power transistors are used to discharge the second smoothing capacitor C2, there is a possibility that the expected effect cannot be obtained. If the transistor temperature Tt is below the lower limit temperature Tmin, there is a high possibility that the transistors are not operating, that is, the transistors are broken. In such a case, too, there is a possibility that even if the power transistors are used for the discharging of the second smoothing capacitor C2, the expected result cannot be obtained. The process shown in FIG. 5 is also intended to prevent activation of the discharge device if there is a possibility that the expected effect of discharge may not be obtained. The processes of step S34 and step S36 correspond to the step of determining whether to activate the discharge device.

In the first embodiment and the second embodiment, the electric motor controller 25 determines whether to activate the discharge device on the basis of the sensor data obtained a predetermined time (5 seconds) before the impact signal is detected (i.e., before the vehicle receives an impact). While the sensor data subsequent to a collision is low in reliability, the sensor data prior to the collision is high in reliability. The motor vehicle of each of the embodiments determines whether to activate the discharge device by using highly reliable sensor data obtained prior to the collision. The motor vehicle of each embodiment is able to appropriately determine whether to activate the discharge device without a need to collect a large amount of sensor data after the collision. In other words, the motor vehicle of each embodiment is able to appropriately determine whether to activate the discharge device according to the situation. In still other words, the technology disclosed in conjunction with the embodiments determines correctly with high probability whether the vehicle is in a situation where the discharge device appropriately operates and, on the basis of a result of the determination, determines whether to activate the discharge device

### Third Embodiment

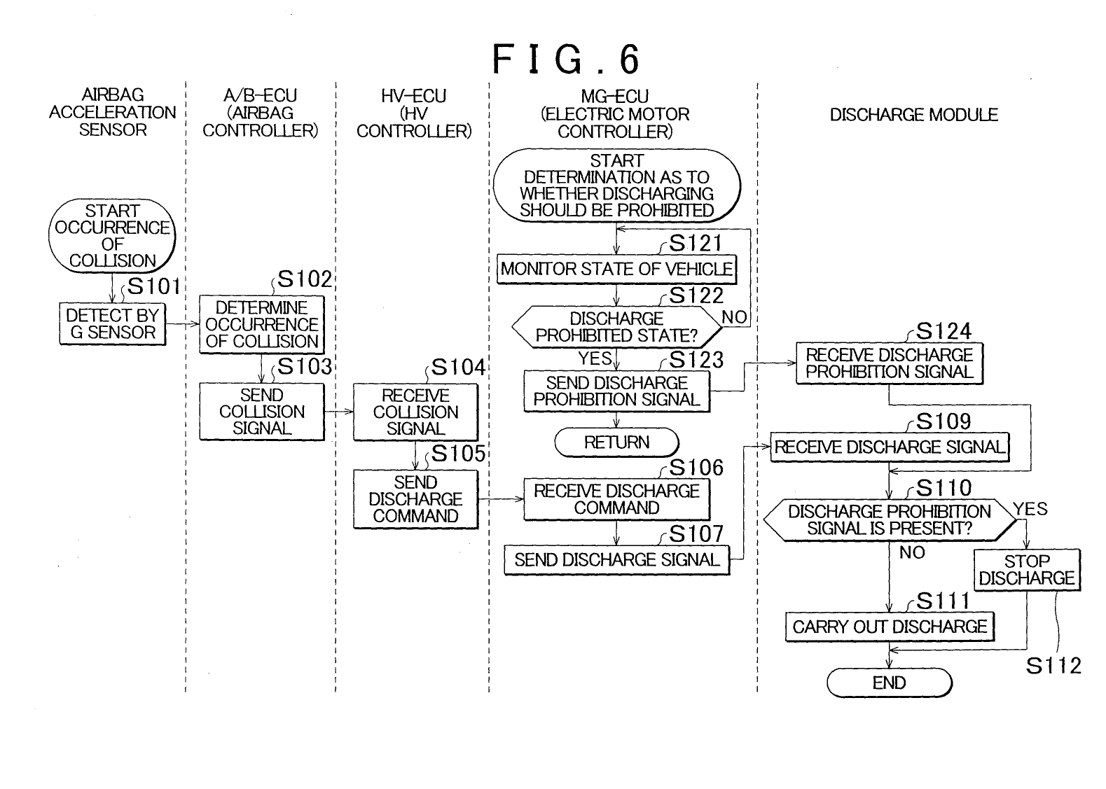

Next, a vehicle in accordance with a third embodiment of the invention will be described. The hardware construction of the motor vehicle of the third embodiment is basically the same as the hardware construction of the motor vehicles of the first and second embodiments shown in FIGS. 1 and 2. However, in the motor vehicle of the third embodiment, the discharge module 29 has its own controller, and the controller performs various determinations on the basis of signals from other controllers (concretely, the motor controller 25). In the motor vehicle of the third embodiment, the airbag controller 5, the HV controller 10, the electric motor controller 25 and the discharge module (the discharge module's own controller) take their shares of the process related to the discharging. FIG. 6 shows a flowchart of a discharge process in the third embodiment.

Firstly, the sensor data obtained by the acceleration sensor 6 is sent to the airbag controller 5 (S101). The airbag controller 5 compares the sensor data from the acceleration sensor with a predetermined threshold value (a threshold value for determining whether there is a collision), and determines that a collision has occurred if the acceleration measured by the acceleration sensor is greater than the threshold value (S102). If the airbag controller 5 determines that a collision has occurred, the airbag controller 5 sends the collision signal to the HV controller 10 (S103). The HV controller 10, after receiving the collision signal (S104), sends the discharge command to the electric motor controller 25 so that the electric motor controller 25 activates the discharge device (S105).

The electric motor controller 25, after receiving the discharge signal (S106), sends the discharge signal to the discharge module 29 (S107). Furthermore, the electric motor controller 25 determines whether the discharging should be prohibited, in a predetermined control cycle, independently of the foregoing process (S121 to S123). The electric motor controller 25 monitors the state of the vehicle (S121). Concretely, in the process of step S121, the motor controller 25 receives sensor data that indicates the state of the vehicle, that is, the sensor data obtained by the voltage sensor Vd (i.e., the inverter input voltage VH)) and the sensor data obtained by the temperature sensors Q (i.e., the temperature Tt of each power transistor Tr), and retains the sensor data at fixed intervals (e.g., every one second) as in the first embodiment. Next, the electric motor controller 25 determines whether activation of the discharge device should be prohibited, on the basis of the sensor data that the electric motor controller 25 retains (S122). Concretely, the electric motor controller 25 performs processes that correspond to the processes of steps S24 and S26 shown in FIG. 4 and the processes of steps S34 and S36 shown in FIG. 5. That is, the electric motor controller 25 prohibits activation of the discharge device if the inverter input voltage VH is greater than the upper limit voltage Vmax and if the input voltage VH is below the lower limit voltage Vmin. Furthermore, the electric motor controller 25 also prohibits activation of the discharge device if the transistor temperature Tt is higher than the upper limit temperature Tmax and if the transistor temperature Tt is below the lower limit temperature Tmin. If the electric motor controller 25 determines to prohibit activation of the discharge device, the electric motor controller 25 sends a discharge prohibition signal to the discharge module 29 (S122 and S123). The discharge module 29; after receiving the discharge prohibition signal, retains the signal (S124). Furthermore, if the discharge module 29 receives the discharge signal (S109), the discharge module 29 determines whether the discharge module 29 is retaining the discharge prohibition signal (S110). If the discharge module 29 is not retaining the discharge prohibition signal, the discharge module 29 activates the discharge device (S111). If the discharge module 29 is retaining the discharge prohibition signal, the discharge module 29 does not activate the discharge device. If the discharge module 29 is retaining the discharge prohibition signal, and has already activated the discharge device at the time of receiving the discharge signal, the discharge module 29 stops operation of the discharge device (S112). In the motor vehicle of the third embodiment, the electric motor controller 25 determines whether the discharging should be prohibited, in a predetermined cycle (S121 to S123), and constantly sends the result of the determination to the discharge module 29. Also in this embodiment, the electric motor controller 25 functions as the control section of the invention and the memory in the electric motor controller 25 functions as the storage section of the invention.

### Fourth Embodiment

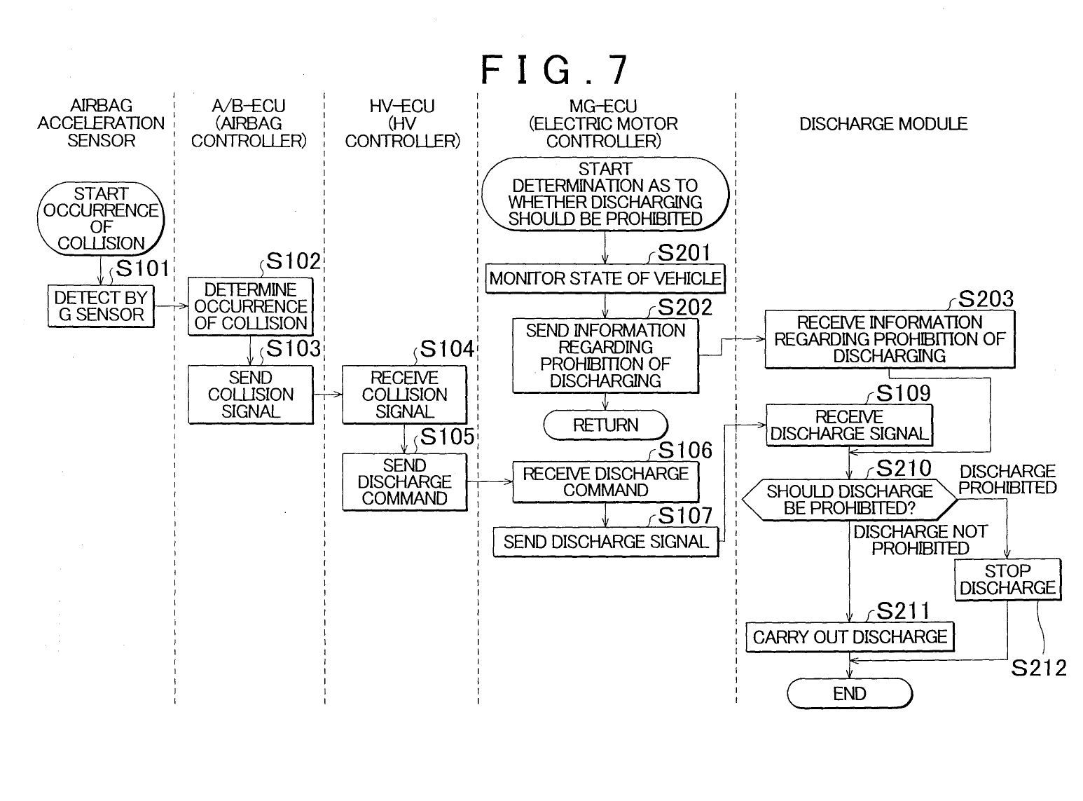

Next, a motor vehicle in accordance with a fourth embodiment of the invention will be described. FIG. 7 shows a flowchart of a discharge process in the fourth embodiment. The discharge process in the fourth embodiment is a modification of the discharge process of the third embodiment. The process of steps S101 to S109 in FIG. 7 is the same as the process of steps S101 to S109 shown in FIG. 6, and description of the process will be omitted. The discharge process of the fourth embodiment is different from the discharge process of the third embodiment in the process in which the electric motor controller 25 determines whether the discharging should be prohibited and in the process that the discharge module 29 performs. The electric motor controller 25 monitors the state of the vehicle (S201), and sends data (information regarding appropriateness of the discharging) obtained from the monitoring to the discharge module 29 (S202). The information regarding appropriateness of the discharging includes sensor data obtained by the voltage sensor Vd (i.e., the inverter input voltage VH) and the sensor data obtained by the temperature sensors Q (i.e., the temperature Tt of each power transistor Tr). The discharge module 29 retains the information regarding appropriateness of the discharging that the discharge module 29 receives (S203). The electric motor controller 25 periodically sends the information regarding appropriateness of the discharging to the discharge module, so that the discharge module 29 periodically updates the information regarding appropriateness of the discharging. Independently of the process of updating the information regarding appropriateness of the discharging, upon receiving the discharge signal from the electric motor controller 25, the discharge module 29 determines whether the discharging should be prohibited (S210). The determination in step S210 is the same as the process of steps S24 and S26 in FIG. 4 and the process of steps S34 and S36 in FIG. 5. That is, the discharge module 29 prohibits activation of the discharge device if the inverter input voltage VH is greater than the upper limit voltage Vmax and if the input voltage VH is below the lower limit voltage Vmin. Furthermore, the discharge module 29 also prohibits activation of the discharge device if the transistor temperature Tt is higher than the upper limit temperature Tmax and if the transistor temperature Tt is below the lower limit temperature Tmin. In this embodiment, the control section and the storage section of the invention (not shown) are integrated in the discharge module 29 with the discharge device of the invention.

The discharge module 29 causes the discharge device to operate if it is possible to allow the discharge device to be activated (S211), and does not activate the discharge device if the discharging needs to be prohibited. If the discharge module 29 has already activated the discharge device when the discharge module 29 determines that the discharging needs to be prohibited, the discharge module 29 stops the activation or operation of the discharge device (S212). That is, the third embodiment and the fourth embodiment are different from each other in that while in the third embodiment, the appropriateness of the discharging is determined mainly by the electric motor controller 25, the means for determining the appropriateness of the discharging in the fourth embodiment is the discharge module 29.

With regard to the foregoing embodiments, points to be noted will be stated. In the foregoing embodiments, the electric motor controller 25 determines whether to activate the discharge device, by using the sensor data obtained prior to a collision. In the motor vehicles of the embodiments, in some cases, activation of the discharge device is prevented if the collision signal is erroneously input to the electric motor controller. For example, according to the communication protocol between the HV controller 10 and the power controller 20, there is a possibility that if the voltage supplied to the sub-battery SB decreases, the voltage level in the signal line may decrease and the power controller 20 may determine that the power controller 20 has received the collision signal. The state where the voltage supplied to the sub-battery SB has decreased is not a state where the motor vehicle is normally traveling. Therefore, there is a high possibility that the sensor data may not be data that is normally exhibited during travel of the vehicle. For example, when the vehicle is in the stopped state, the input voltage VH of the inverter is substantially zero, and the temperature Tt of each transistor in the inverter is also low. According to the process shown in FIG. 4 or FIG. 5, if the input voltage VH is lower than the lower limit voltage and if the temperature Tt of each transistor within the inverter is lower than the lower limit temperature, the electric motor controller 25 does not activate the discharge device. The processes shown in FIG. 4 and FIG. 5 have an advantage that the electric motor controller prevents activation of the discharge device if the motor control receives a false collision signal that results from low voltage of the sub-battery SB.

The retention of the sensor data through the use of the ring buffer for a fixed period of time shown in FIG. 3 is an example of the retention process, and other techniques may also be used to retain the sensor data for a fixed period of time. For example, the retention process may be realized by using a first-in first-out (FIFO) memory.

In the second embodiment, the temperature Tt of each transistor is used as a basis to determine whether to activate the discharge device. Instead of the temperatures Tt of the transistors, the temperature of a cooling medium that cools the power transistors may be used. In this case, it is to be noted that for the upper limit temperature Tmax and the lower limit temperature Tmin, different threshold values should be used. The sensor data to be retained in preparation for a collision is not limited to the inverter input voltage, the temperature of the power transistors or the temperature of the cooling medium. For example, it is also preferable to retain data from sensors that detect the vehicle speed, the temperature of an electric motor, etc. and to use the sensor data as a factor that is taken into account in the determination at the time of a collision.

In the foregoing embodiments, the discharge resistor, the power transistors provided within the inverter or the electric motors are adopted as discharge devices. Besides these devices, various electricity-consuming devices that are normally installed in the motor vehicle, such as the air-conditioner, the horn, the headlights, etc., can also be preferably used.

In the embodiments, the collision signal is output if the value provided by the acceleration sensor of the airbag system exceeds the predetermined threshold value. The signal for activating the discharge device can also be output on the basis of data or the like other than the sensor data from the acceleration sensor. For example, in the systems of the third and fourth embodiments, the HV controller 10 may send the discharge command when the power supply voltage becomes below a predetermined threshold voltage value (see step S105 in FIGS. 6 and 7).

In the foregoing embodiments, the motor vehicle is a hybrid vehicle. However, the technology disclosed by this specification is also applicable to electric motor vehicles (including fuel cell vehicles).

Representative and non-restrictive concrete embodiments of the invention have been described in detail with reference to the accompanying drawings. This detailed description is simply intended to show details of embodiments of the invention to those having ordinary skill in the art, and is not intended to limit the scope of the invention to these embodiments. Furthermore, any of the disclosed additional features and the inventions can be used separately from or together with other features and inventions in order to provide further improved motor vehicles.

Furthermore, combinations of the features and the process steps disclosed in the foregoing detailed description are not essential to carry out the invention in the broadest meaning, and are described only for the purpose of particularly describing representative concrete embodiments of the invention. Still further, various features of the foregoing representative concrete embodiments and various features of what are described in the independent and dependent claims do not necessarily need to be combined in the same manners as in the described concrete embodiments or in the same sequences or orders as mentioned above, in providing additional and useful embodiments of the invention.

1. A motor vehicle having a traction motor, comprising:
a capacitor that smoothes electric current that is used to drive the traction motor;
a discharge device capable of releasing electric charge stored in the capacitor; and
a control section configured to receive sensor data that indicates a state of the motor vehicle and to determine, based on the sensor data received, whether activation of the discharge device should be prohibited.

2. The motor vehicle according to claim 1, wherein
the control section is separate from the discharge device.

3. The motor vehicle according to claim 1, wherein
the control section is configured to constantly send to the discharge device a result of determination as to whether activation of the discharge device should be prohibited.

4. The motor vehicle according to claim 1, wherein
the control section is integrated with the discharge device.

5. The motor vehicle according to claim 1, wherein
the control section is configured so that, when the motor vehicle receives an impact, the control section determines whether activation of the discharge device should be prohibited, based on the sensor data that the control section receives before the motor vehicle receives the impact.

6. The motor vehicle according to claim 5, wherein
the control section is configured to determine whether activation of the discharge device should be prohibited, based on the sensor data that the control section receives at least a predetermined time before the motor vehicle receives the impact.

7. The motor vehicle according to claim 5, wherein
the “when the motor vehicle receives an impact” is when acceleration measured by an acceleration sensor provided in the motor vehicle exceeds a predetermined threshold acceleration value.

8. The motor vehicle according to claim 5, further comprising
an acceleration sensor, wherein
the control section is configured to determine that the motor vehicle has received the impact, when acceleration measured by the acceleration sensor exceeds a predetermined threshold acceleration value.

9. The motor vehicle according to claim 7, wherein
the control section is disposed in a front compartment of the motor vehicle, and the acceleration sensor is disposed in a cabin compartment.

10. The motor vehicle according to claim 1, wherein
the discharge device includes at least one of a discharge resistor, the traction motor, a power transistor provided in an electric motor controller.

11. The motor vehicle according to claim 10, wherein:
the discharge device includes the discharge resistor;
the sensor data includes input voltage of an inverter provided in the electric motor controller; and
the control section is configured to activate the discharge device if the input voltage is lower than a predetermined upper limit voltage and not to activate the discharge device if the input voltage is higher than the upper limit voltage.

12. The motor vehicle according to claim 11, wherein
the control section is configured to activate the discharge device if the input voltage is higher than a predetermined lower limit voltage that is lower than the upper limit voltage and not to activate the discharge device if the input voltage is lower than the lower limit voltage.

13. The motor vehicle according to claim 10, wherein:
the discharge device includes the power transistor provided in the electric motor controller;
the sensor data includes temperature of the power transistor or temperature of a cooling medium that cools the power transistor; and
the control section is configured to activate the discharge device if the temperature of the power transistor or the temperature of the cooling medium is lower than a predetermined upper limit temperature and not to activate the discharge device if the temperature of the power transistor or the temperature of the cooling medium is higher than the upper limit temperature.

14. The motor vehicle according to claim 1, wherein
the control section includes a storage section configured to retain a result of determining whether activation of the discharge device should be prohibited, and
the control section is configured not to activate the discharge device or to stop operation of the discharge device when the result of the determining that activation of the discharge device should be prohibited is retained in the storage section.

15. The motor vehicle according to claim 1, wherein
the control section is configured to receive sensor data that indicates a state of the motor vehicle and to determine, based on the sensor data received, whether activation of the discharge device should be prohibited even if a collision signal has been received.

16. The motor vehicle according to claim 8, wherein
the control section is disposed in a front compartment of the motor vehicle, and the acceleration sensor is disposed in a cabin compartment.
